(19) United States
(12) Patent Application Publication
(10) Pub. No.: US 2019/0212798 A1
(43) Pub. Date: Jul. 11, 2019

(54) DISABLE POWER BUTTON

(71) Applicant: HEWLETT-PACKARD DEVELOPMENT COMPANY, L.P., HOUSTON, TX (US)

(72) Inventors: HSIN-MING YANG, TAIPEI CITY (TW); MING-TE CHANG, TAIPEI CITY (TW); HU-YU YANG, TAIPEI CITY (TW)

(21) Appl. No.: 16/323,004

(22) PCT Filed: Sep. 29, 2016
(86) PCT No.: PCT/US2016/054539

§ 371 Date: Feb. 4, 2019

(51) Int. Cl. G06F 1/26; G06F 1/16; G06F 21/81

(52) U.S. Cl. CPC G06F 1/266; G06F 1/1677; H01H 2231/042; H01H 2221/068; G06F 21/81

(57) ABSTRACT

Examples disclosed herein relate to a power button. Examples include a device including a power button to activate a power supply of the device. A controller of the device to determine whether the device is in disabled power event state and to disable the power button when the device in the disabled power event state.

### BACKGROUND

A number of devices operate under the control of a power button to activate a power source. In some examples, power buttons may be hardware switches to activate the flow of power. In other examples, power buttons may be implemented in firmware. In yet other examples, power buttons may be implemented in a combination of firmware and hardware. In examples, a power source may be internal to the device, such as a battery, or external to the device, such as a wall power source. In some such devices, unpowered device may use an internal power source to operate certain components when a main power source is not operational.

### BRIEF DESCRIPTION OF THE DRAWINGS

The following detailed description references the drawings, wherein:

FIG. 1 is a block diagram of a device according to an example.

FIG. 2 is a block diagram of a system according to an example.

FIG. 3 is a flowchart of a method for controlling a power supply according to an example.

FIG. 4 is a flowchart of a method for controlling a power supply according to an example.

FIG. 5 is a block diagram of a computing device according to an example.

### DETAILED DESCRIPTION

Devices generally have a power button in an easy to access location. Reconfigurable devices are devices that may be used in multiple configurations by changing an orientation or arrangement of components of the device. In some configurations, the power button may be disposed such that a user may inadvertently actuate the power button. Devices may operate in multiple power modes and it may damage a device to have the power button actuated inadvertently.

To address these issues, in the examples described herein, a device to disable a power button is described. In examples, the device includes a controller to determine to enter a disabled power event state. In such examples, the device may enter the disabled power event state according to the configuration of the device. In such examples, the device may enter the disabled power event state when a lid of the device is closed and the device is not coupled to a peripheral device.

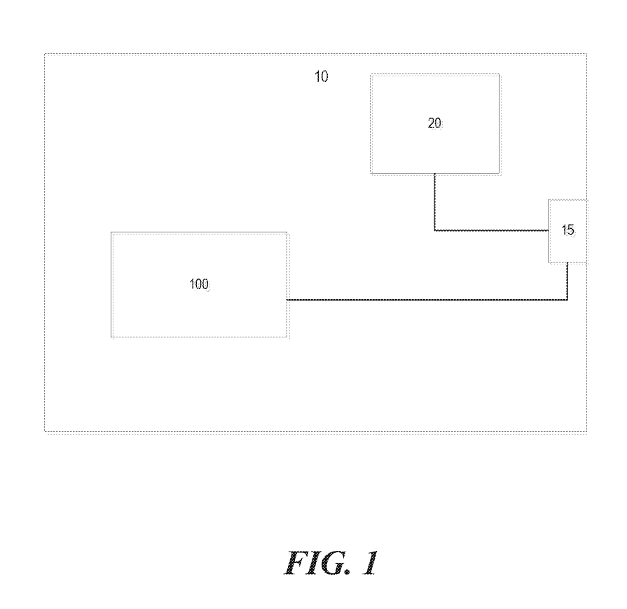

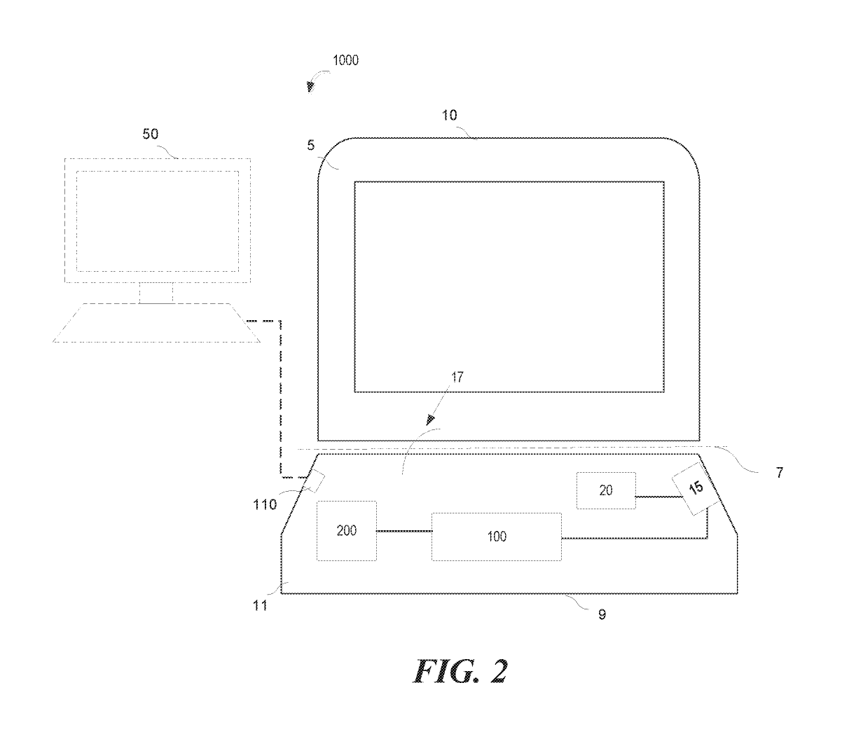

Referring now to the drawings, FIG. 1 is a block diagram of a device 10 according to an example. FIG. 2 is a block diagram of a system 1000 according to an example. A “device” may be any device operating under a power source. A “computing device” may be a device, such as a laptop computer, notebook computer, clam shell computer, workstation, tablet computer, mobile phone, smartphone, smart device, or any other processing device or equipment, with a housing having a side that may rotate about an axis. In examples, device 10 includes a power button 15, a power supply 20, and a controller 100. In examples, device 10 may include a sensor 200 and an interface 110. In examples, device 10 may include a housing 11 which includes a side 5 and a side 9. In examples, side 5 and/or side 9 may rotate about a central axis 7 of housing 11. In examples, an angle 17 may be formed between side 5 and side 9.

In examples, system 1000 may include device 10 and a peripheral device 50. In examples, device 10 may be a reconfigurable computing device. In such examples, peripheral device 50 may be coupled to device 10. In the following discussion and in the claims, the term “couple” or “couples” is intended to include suitable indirect and/or direct connections. Thus, if a first component is described as being coupled to a second component, that coupling may, for example, be: (1) through a direct electrical or mechanical connection, (2) through an indirect electrical or mechanical connection via other devices and connections, (3) through an optical electrical connection, (4) through a wireless electrical connection, and/or (5) another suitable coupling. For example, device 10 may be coupled to peripheral device 50 via a High-Definition Multimedia Interface (“HDMI”), a Video Graphics Array (“VGA”), a Universal Serial Bus (“USB”), a USB Type-C, or any other cable coupling mechanism. The term “connect” or “connected” is intended to include suitable direct connections. In examples, peripheral device 50 may be any type of peripheral device to couple to device 10. For examples, peripheral device 50 may be a peripheral device to couple to a computing device, such as a monitor, a keyboard, a mouse, a printer, etc.

In examples, power button 15 may be any device used to interrupt a flow of electrons in a circuit. In examples, power button 15 may be a mechanical and/or electrical switch to actuate the supply of power from power source 20 to device 10. In examples, power source 20 may be a main power source of device 10. In such examples, power source 20 may be an internal power source, such as a battery, or an external power source, such as a mains electrical supply, coupled to device 10. In examples, power button 15 may be disposed on or integrated into housing 11. In some examples, device 10 may include more than one power source 20. For example, device 10 may include a secondary power source, such as a battery, to power certain components of device 10 regardless of whether power source 20 is coupled to device 10 and actuated by power button 15 to supply power to device 10. In such an example, controller 100 may be powered by a secondary power source in some power states of device 10.

In examples, controller 100 may be any chip, expansion card, standalone device, or circuit to communicate with another component of the device 10. In examples, controller 100 may manage the operation of power button 15 and thereby power source 20. In examples, controller 100 may determine whether to disable or deactivate power button 15. In such examples, controller 100 may determine to enter a disabled power event state in which device 10 disregards a power button event of power button 15. As used herein, a “power button event” refers to actuation of the power button by physical means, such as a touch, a pull, a tap, etc. A “disabled power event state” refers to a state in which device 10 disregards a power button event passively acquired (i.e., received) or actively acquired (i.e., retrieved) in the device. In other words, device 10 may ignore or disregard actuation of power button 15 when in the disabled power event state. In contrast, an “active power event state” refers to a state in which device 10 responds to actuation of power button 15 to change a power state of device 10. In such examples, device 10 may be in any power state and may enter a different power state according to instructions stored in device 10. For example, in an active power event state, device 10 may power off in response to an acquired power event. In other examples, device 10 may power on in response to an acquired power event. In yet other examples, device 10 may enter a hibernate mode or sleep mode in response to an acquired power event.

In examples, controller 100 may determine to enter the disabled power event state according to a configuration state of device 10. In such examples, controller 100 may determine to enter the disabled power event state when angle 17 between side 5 and side 9 of housing 11 is within a certain range. In examples, the certain range may be less than 15 degrees. In other words, device 10 may enter the disabled power event state when the angle between side 5 and side 9 is less than 15 degrees, i.e., when a lid (either of side 5 or side 9) of device 10 is at least substantially closed. In the examples described herein, a lid of a device is considered “closed” when side 5 and side 9 are separated by less than 15 degrees. In other words, the lid of device 10 may be considered closed when angle 17 is in a range less than 15 degrees.

In examples, sensor 200 may be any sensor to determine angle 17 between side 5 and side 9. In examples, sensor 200 may be at least one of a G-sensor, a Hall sensor, an accelerometer, a MEMS accelerometer, etc. In an example, sensor 200 may be a G-sensor to sense the force of gravity on side 5 and side 9 and determine angle 17 accordingly. In examples, sensor 200 may be integrated into controller 100 or may be a separate component of device 10.

In examples, interface 110 may be any input/output interface to couple device 10 to peripheral device 50. In examples, interface 110 may be hardware and/or a combination of firmware and hardware to couple device 10 to peripheral device 50. For example, interface 110 may be a general purpose input/output (“GPIO”). In such an example, controller 100 may determine whether peripheral device 50 is coupled to device 10 by polling a pin status of the GPIO. In such examples, controller 100 may determine to remain in an active power event state in response to determining a peripheral device 50 is coupled to the device 10. In other words, when a peripheral device 50 is coupled to device 10, power button 15 may remain activated regardless of the relative position of side 5 and side 9. In examples, interface 110 may be a component of controller 100.

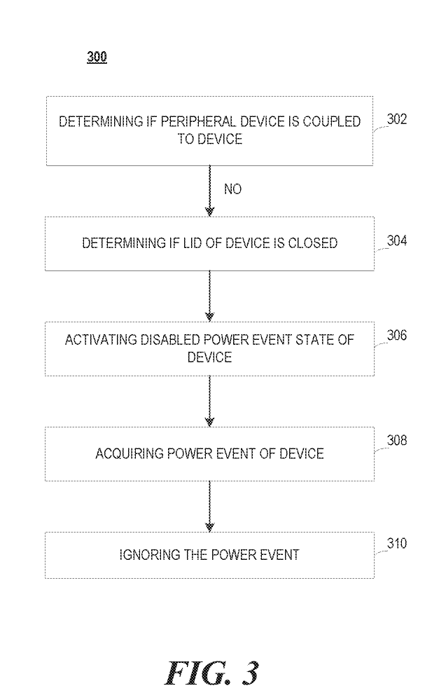

FIG. 3 is a flowchart of an example method 300 for controlling a power supply.

Although execution of method 300 is described below with reference to device 10 and system 1000 described above, other suitable systems for the execution of method 300 can be utilized. Additionally, implementation of method 300 is not limited to such examples.

At 302 of method 300, device 10 may determine if peripheral device 50 is coupled to device 10. In the example of FIG. 3, controller 100 may poll interface 110 to determine whether peripheral device 50 is coupled to device 10. In such an example, interface 110 may be a GPIO.

At 304, device 10 may determine if a lid of device 10 is closed when peripheral device 50 is uncoupled to device 10. In examples, a lid of device 10 may be closed when side 5 of housing 11 and side 9 of housing 11 are less than 15 degrees apart. In such an example, sensor 200 may be a G-sensor to determine an angle between side 5 and side 9. In other examples, sensor 200 may be Hall sensor to determine when the lid of device 10 is closed. In such an example, sensor 200 may determine whether side 5 and side 9 are within a certain proximity to each other based on a generated magnetic field.

At 306, device 10 may activate the disabled power event state of device 10. In examples, controller 100 may disable power button 15 in the disabled power event state. In some examples, controller 100 may disable power button 15 via hardware and/or firmware.

At 308, device 10 may passively acquire (i.e., receive) or actively acquire (e.g., retrieve) a power event of device 10. In examples, the power event may be actuation of power button 15.

At 310, device 10 may ignore the power event. In examples, controller 100 may disregard or ignore the power event. In such examples, actuation of power button 15 may not alter a power state of device 10.

Although the flowchart of FIG. 3 shows a specific order of performance of certain functionalities, method 300 is not limited to that order. For example, the functionalities shown in succession in the flowchart may be performed in a different order, may be executed concurrently or with partial concurrence, or a combination thereof. In some examples, functionalities described herein in relation to FIG. 3 may be provided in combination with functionalities described herein in relation to any of FIGS. 1-2 and 4-5.

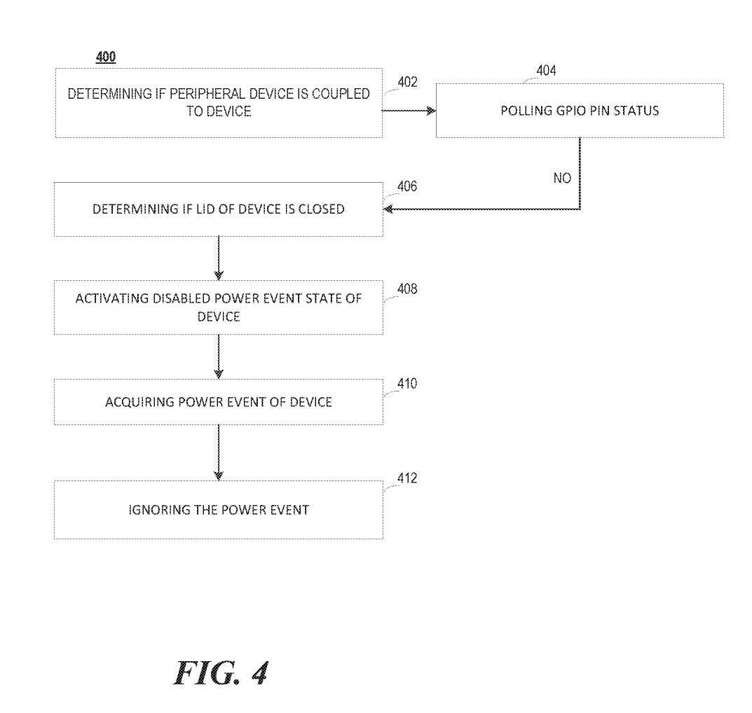

FIG. 4 is a flowchart of an example method 400 for controlling a power supply. Although execution of method 400 is described below with reference to device 10 and system 1000 described above, other suitable systems for the execution of method 400 can be utilized. Additionally, implementation of method 400 is not limited to such examples.

At 402 of method 400, device 10 may determine if peripheral device 50 is coupled to device 10.

At 404, controller 100 may poll interface 110 to determine whether peripheral device 50 is coupled to device 10. In the example of FIG. 4, interface 110 may be a GPIO. In such examples, controller 100 may poll a GPIO pin status.

At 406, device 10 may determine if a lid of device 10 is closed when peripheral device 50 is uncoupled to device 10. In examples, a lid of device 10 may be closed when side 5 of housing 11 and side 9 of housing 11 are less than 15 degrees apart. In such an example, sensor 200 may be a G-sensor to determine an angle between side 5 and side 9. In other examples, sensor 200 may be Hall sensor to determine when the lid of device 10 is closed. In such an example, sensor 200 may determine whether side 5 and side 9 are within a certain proximity to each other based on a generated magnetic field.

At 408, device 10 may activate the disabled power event state of device 10. In examples, controller 100 may disable power button 15 in the disabled power event state. In some examples, controller 100 may disable power button 15 via hardware and/or firmware.

At 410, device 10 may passively acquire (i.e., receive) or actively acquire (e.g., retrieve) a power event of device 10. In examples, the power event may be actuation of power button 15.

At 412, device 10 may ignore the power event. In examples, controller 100 may disregard or ignore the power event. In such examples, actuation of power button 15 may not alter a power state of device 10.

Although the flowchart of FIG. 4 shows a specific order of performance of certain functionalities, method 400 is not limited to that order. For example, the functionalities shown in succession in the flowchart may be performed in a different order, may be executed concurrently or with partial concurrence, or a combination thereof. In some examples, functionalities described herein in relation to FIG. 4 may be provided in combination with functionalities described herein in relation to any of FIGS. 1-3 and 5.

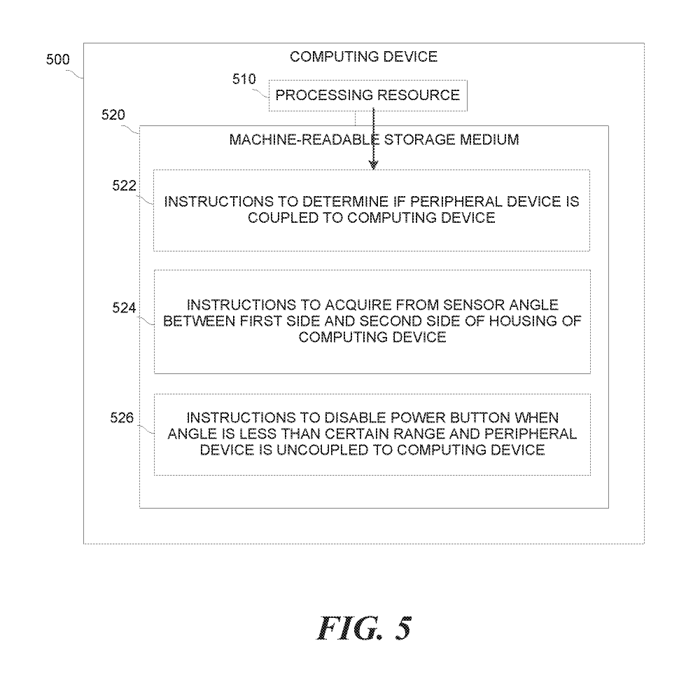

FIG. 5 is a block diagram of an example computing device 500 to disable a power button. In the example of FIG. 1, computing device 500 includes a processing resource 510 and a machine readable storage medium 520 comprising (e.g., encoded with) instructions 522, 524, and 526 executable by processing resource 510. In some examples, storage medium 520 may include additional instructions. In some examples, instructions 522, 524, 526 and any other instructions described herein in relation to storage medium 520, may be stored on a machine-readable storage medium remote from but accessible to computing device 500 and processing resource 510 (e.g., via a computer network). In some examples, instructions 522, 524, and 526 may be instructions of a computer program, computer application (app), agent, or the like, of computing device 500. In other examples, the functionalities described herein in relation to instructions 522, 524, and 526 may be implemented as engines comprising any combination of hardware and programming to implement the functionalities of the engines, as described below.

In examples described herein, a processing resource may include, for example, one processor or multiple processors included in a single computing device (as shown in FIG. 5) or distributed across multiple computing devices. A “processor” may be at least one of a central processing unit (CPU), a semiconductor-based microprocessor, a graphics processing unit (GPU), a field-programmable gate array (FPGA) to retrieve and execute instructions, other electronic circuitry suitable for the retrieval and execution of instructions stored on a machine-readable storage medium, or a combination thereof. Processing resource 510 may fetch, decode, and execute instructions stored on storage medium 520 to perform the functionalities described below. In other examples, the functionalities of any of the instructions of storage medium 520 may be implemented in the form of electronic circuitry, in the form of executable instructions encoded on a machine-readable storage medium, or a combination thereof.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory.

In the example of FIG. 5, in instructions 522 controller 100 may determine if a peripheral device 50 is coupled to device 10.

In instructions 524, device 10 may acquire from sensor 200 angle 17 between side 5 and side 9. In examples, sensor 200 may be a G-sensor.

In instructions 526, device 10 may disable power button 15 when angle 17 is less than a certain range and peripheral device 50 is uncoupled to computing device 50. In such an examples, the certain range may be less than 15 degrees. In such examples, device 10 may be in disabled power event state when device 10 is uncoupled to peripheral device 50 and angle 17 is less than 15 degrees. In contrast, device 10 may be in an active power event state when device 10 is coupled to peripheral device 50 regardless of the size of angle 17. In such examples, peripheral device 50 may be a monitor, a keyboard, a mouse, a printer, etc.

In some examples, instructions 522, 524, and 526 may be part of an installation package that, when installed, may be executed by processing resource 510 to implement the functionalities described herein in relation to instructions 522, 524, and 526. In such examples, storage medium 520 may be a portable medium, such as a CD, DVD, flash drive, or a memory maintained by a computing device from which the installation package can be downloaded and installed. In other examples, instructions 522, 524, and 526 may be part of an application, applications, or component already installed on computing device 500 including processing resource 510. In such examples, the storage medium 520 may include memory such as a hard drive, solid state drive, or the like. In some examples, functionalities described herein in relation to FIG. 5 may be provided in combination with functionalities described herein in relation to any of FIGS. 1-4.

What is claimed is:

1. A device, comprising:
a power button to activate a power supply of the device; and
a controller to determine whether the device is in disabled power event state and to disable the power button when the device in the disabled power event state.

2. The device of claim 1, wherein the device will disregard a power button event when in the disabled power event state.

3. The device of claim 1, wherein the disabled power event state is determined according to the angle between a first side of a housing and a second side of the housing.

4. The device of claim 3, wherein the first side of the housing and the second side of the housing rotate about a central axis.

5. The device of claim 3, further comprising:
a sensor to determine the angle between the first side of the housing and the second side of the housing.

6. The device of claim 1, further comprising:
a sensor to determine if a peripheral device is coupled to the device,
wherein the device remains in an active power event state when the peripheral device is coupled to the device.

7. The device of claim 6, wherein the sensor is a component of the controller.

8. The device of claim 7, wherein the interface is a general purpose input/output.

9. A method for controlling a power supply, comprising:
determining if a peripheral device is coupled to a device;
determining if a lid of the device is closed when the peripheral device is uncoupled to the device;
activating a disabled power event state of the device;
acquiring a power event of the device; and
ignoring the power event.

10. The method of claim 9, further comprising:
polling a general purpose input/output (“GPIO”) pin status.

11. The method of claim 10, wherein determining a lid of a device is closed is according to the angle between a first side of a housing and a second side of the housing.

12. The method of claim 11, wherein the lid is closed when the angle is less than 15 degrees.

13. A non-transitory machine-readable storage medium comprising instructions executable by a processing resource to:
determine if a peripheral device is coupled to a computing device;
acquire from a sensor an angle between a first side of a housing of the computing device and a second side of the housing of the computing device; and
disable a power button when the angle is less than a certain range and a peripheral device is uncoupled to the computing device.

14. The storage medium of claim 13, wherein the certain range is less than 15 degrees.

15. The storage medium of claim 13, wherein the sensor is a G-sensor.
